(19) United States
(12) Patent Application Publication
(10) Pub. No.: US 2015/0083823 A1
(43) Pub. Date: Mar. 26, 2015

(54) COUPLING AND UNCOUPLING MECHANISM FOR AN ONBOARD DEVICE OF A TURBOJET ENGINE NACELLE

(71) Applicant: AIRCELLE, GONFREVILLE L'ORCHER (FR)

(72) Inventors: Hervé HURLIN, IGNY (FR); Olivier GILO, VERSAILLES (FR); Olivier KERBLER, ANTONY (FR)

(21) Appl. No.: 14/558,833

(22) Filed: Dec. 3, 2014

Related U.S. Application Data
(63) Continuation of application No. PCT/FR2013/051554, filed on Jul. 2, 2013.

(30) Foreign Application Priority Data
Jul. 5, 2012 (FR) 12/56438
Aug. 8, 2012 (FR) 12/57685

(51) Int. Cl. F02K 1/76; F16D 11/14

(52) U.S. Cl. CPC F02K 1/763; F16D 11/14
USPC 239/265.19; 192/69

(57) ABSTRACT

A mechanism for coupling and uncoupling a motor inlet shaft and an outlet shaft, in particular, the inlet shaft is mounted in rotation on a front frame, and the outlet shaft is mounted in rotation on a rear frame. The outlet shaft rotates an outlet pinion, and the rear frame is slidably mounted to translate between a forward compact position and a backward deployed position. The mechanism includes a coupler, and first and second lockers to couple or uncouple the inlet and outlet shafts according to the translation of the rear frame between the forward compact position and the backward deployed position. The first locker locks in rotation the inlet shaft on the front frame, the second locker locks the outlet shaft on the rear frame. In particular, the second locker automatically locks the inlet and outlet shafts in rotation respectively, according to the displacement of the rear frame.

### CROSS-REFERENCE TO RELATED APPLICATIONS

This application is a continuation of International Application No. PCT/FR2013/051554, filed on Jul. 2, 2013, which claims the benefit of FR 12/56438, filed on Jul. 5, 2012, and FR 12/57685, filed on Aug. 8, 2012. The disclosures of the above applications are incorporated herein by reference.

### FIELD

The present disclosure relates to a coupling and uncoupling mechanism for a turbojet engine nacelle equipped with a thrust reversal device.

### BACKGROUND

The statements in this section merely provide background information related to the present disclosure and may not constitute prior art.

A nacelle generally exhibits a longitudinal tubular structure comprising, from front to back, an air inlet upstream of the turbojet engine, a median section intended to surround a fan of the turbojet engine, a downstream section accommodating a thrust reversal device and intended to surround the combustion chamber of the turbojet engine, and is generally terminated by an ejection nozzle of which the outlet is located downstream of the turbojet engine.

Modern nacelles are intended to accommodate a dual flow turbojet engine able to generate by means of the blades of the fan in rotation a hot air flow, also called primary flow, from the combustion chamber of the turbojet engine, and a cold air flow, or secondary flow, which circulates outside the turbojet engine through an annular passage, also called secondary stream, formed between a fairing of the turbojet engine and an inner wall of the nacelle. The two air flows are ejected from the turbojet engine by the rear of the nacelle.

The role of a thrust reversal device is, during the landing of an aircraft, to improve the braking capacity thereof by redirecting towards the front at least part of the thrust generated by the turbojet engine. In this phase, the reverser obstructs at least the stream of cold flow and directs the latter towards the front of the nacelle, thereby generating a counter-thrust which is added to the braking of the wheels of the aircraft.

The means implemented to achieve this reorientation of the cold flow vary depending on the type of reverser.

In the case of a deviation grid reverser, the thrust reversal device comprises deviation grids having for function to reorient the air flow, and which are often associated with reversal shutters and at least one movable cowl.

The cowl is slidably mounted in translation from front to back on the structure of the nacelle, along a direction which is substantially parallel with a longitudinal axis of the nacelle, between a forward compact position in which the cowl closes a passage intended for the diverted flow, and a backward deployed position in which the cowl opens this passage and uncovers the deviation grids.

Furthermore, apart from its thrust reversal function, the sliding cowl comprises a downstream portion forming the ejection nozzle aiming to channel the ejection of the air flows.

The nozzle is designed to modulate the thrust by making its outlet section vary in response to variations in the adjustment of the power of the engine and flight conditions.

This type of movable nozzle with a variable section is known by the name of adapted nozzle, or under acronyms VFN for Variable Fan Nozzle or VAFN for Variable Area Fan Nozzle.

According to the most known alternative forms, the adapted nozzle may be a single piece, or formed from a set of juxtaposed deflectors.

The deflectors are driven in movement by means of a longitudinal outlet shaft which is onboard the movable cowl, the outlet shaft being driven in rotation by means of a motor inlet shaft which is integral with the structure of the nacelle.

It is known from document WO-2011/135217-A1 to provide a mechanism which is designed to couple in rotation the inlet shaft and the outlet shaft together when the cowl occupies its forward compact position, and uncouple the inlet shaft and the outlet shaft when the cowl occupies its backward deployed position.

This coupling mechanism is of claw type, the inlet shaft comprising a first toothing and the outlet shaft comprising a second complementary toothing which is designed to engage with the first toothing.

The coupling of the outlet shaft and the inlet shaft is achieved by axial imbrication of the first toothing in the second toothing during the displacement of the cowl towards its forward compact position.

In order to allow this imbrication, the outlet shaft must be blocked angularly in rotation.

To this end, the mechanism according to document WO-2011/135217-A1 comprises a means for locking in rotation the outlet shaft which allows locking the outlet shaft in rotation as a result of the displacement of the cowl towards its backward deployed position.

This mechanism is not entirely satisfactory as nothing is provided to block and lock in rotation the motor inlet shaft, thus risking jeopardizing the coupling of the inlet shaft with the outlet shaft in the event of an untimely rotation of the inlet shaft.

### SUMMARY

The present disclosure proposes a mechanism of a turbojet engine nacelle, for coupling and uncoupling a motor inlet shaft which is mounted in rotation on a front frame around a secondary longitudinal axis, and an outlet shaft which is mounted in rotation on a rear frame around the secondary axis and which drives in rotation an outlet pinion, the rear frame being slidably mounted from front to back with respect to the front frame, along a longitudinal direction, between a forward compact position and a backward deployed position, the mechanism being equipped with a coupling means which is designed to couple in rotation the inlet shaft and the outlet shaft together when the rear movable frame occupies its forward compact position, and uncouple the inlet shaft and the outlet shaft when the rear frame occupies its backward deployed position, characterized in that the mechanism comprises a first means for locking in rotation the inlet shaft on the associated front frame, and a second means for locking in rotation the outlet shaft on the associated rear frame, which are designed to automatically lock the inlet shaft and the outlet shaft in rotation respectively, under the effect of the displacement of the rear movable frame toward its backward deployed position.

According to another feature, the first means for locking the inlet shaft, of claw type, comprises:

a first locking pinion which is linked in rotation on the inlet shaft around the secondary axis and which delimits a first radial toothing oriented towards the front,

a locking ferrule which delimits a second radial toothing arranged facing said first toothing, the locking ferrule being slidably mounted axially on the front frame between a front unlocking position in which the first toothing is arranged facing the second associated toothing, and a rear locking position in which the first toothing cooperates with the second toothing to lock in rotation the inlet shaft on the associated front frame,

a first elastic return means which is axially interposed between the front frame and the locking ferrule and which automatically returns the locking ferrule towards its rear locking position, and the rear movable frame comprises a bearing portion which is designed to axially bear against the locking ferrule towards the front, such that the locking ferrule is axially constrained in its front unlocking position countering the first elastic return means when the rear frame occupies its forward compact position, and the ferrule is automatically released in its rear locking position when the rear frame is driven towards its backward deployed position.

According to this feature, the locking in rotation of the inlet shaft is achieved in an automatic manner by displacing the rear frame.

Similarly, the second means for locking the outlet shaft, of claw type, comprises:

a third radial toothing which is integral with the rear frame and which is oriented backwards,

a second locking pinion which is linked in rotation on the outlet shaft around the secondary axis and which delimits a fourth radial toothing arranged facing said third toothing,

an axial sliding means for guiding the outlet shaft between a rear unlocking position in which the third toothing is arranged facing the fourth toothing, and a front locking position in which the third toothing cooperates with the fourth toothing to lock in rotation the outlet shaft on the associated rear frame,

a second elastic return means which is axially interposed between the rear frame and the second locking pinion to automatically return the outlet shaft towards its front locking position, in such a manner that the outlet shaft is axially constrained in its rear unlocking position countering the second elastic return means when the rear movable frame occupies its forward compact position, and the outlet shaft is automatically released in its front locking position when the rear movable frame is driven towards its backward deployed position.

According to this feature, the locking in rotation of the outlet shaft is achieved automatically by displacing the rear frame, following the locking of the inlet shaft.

Moreover, the mechanism is designed in such a manner that the first locking means locks the inlet shaft before the second locking means locks the outlet shaft.

This feature prevents an untimely rotation of the inlet shaft after the outlet shaft has been locked in rotation.

In addition, the mechanism is designed in such a manner that the coupling means uncouples the inlet shaft and the outlet shaft after the locking in rotation of the inlet shaft and the outlet shaft.

This feature allows maintaining the angular orientation of the inlet shaft and the outlet shaft to allow the recoupling of theses shafts following the uncoupling.

Moreover, the means for coupling the inlet shaft with the outlet shaft is of claw type and comprises a first coupling portion with axial toothing which is arranged on a rear axial end of the inlet shaft, and a second coupling portion with axial toothing of complementary shape which is arranged on a front axial end of the outlet shaft.

According to another aspect, the mechanism is designed to drive in rotation a receiving element which is mounted in rotation around a main longitudinal axis and which is designed to drive in movement an adapted nozzle of the turbojet engine.

In addition, the inlet shaft is secured in rotation to a motor pinion which delimits a toothing of the same diameter as the toothing of the outlet pinion and which is axially adjoined to the outlet pinion when the outlet shaft occupies its rear unlocking position, and the receiving element is secured in axial translation to the rear frame, the receiving element delimiting a receiving toothing designed to axially slide from the toothing of the motor pinion, onto the toothing of the outlet pinion during the sliding of the outlet shaft towards its front locking position to allow the locking in rotation of the receiving element.

According to this feature, the receiving element is locked in rotation when the rear frame occupies its backward deployed position and that the inlet shaft is uncoupled from the outlet shaft.

In addition, the receiving element is an annular ring which comprises:

an outer peripheral annular portion which cooperates with a complementary housing formed in the rear frame to secure the receiving element and the rear frame in axial translation, and

an inner annular portion which delimits the receiving toothing which is designed to engage with the motor pinion and the outlet pinion.

In addition, the rear frame is carried by a movable cowl of an onboard thrust reversal device of a turbojet engine.

The present disclosure also relates to a turbojet engine nacelle, characterized in that it is equipped with a coupling and uncoupling mechanism according to any one of the preceding claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view, which illustrates a nacelle of a turbojet engine of an aircraft comprising a movable cowl represented in its forward compact position;

FIG. 2 is a perspective view, which illustrates the nacelle of FIG. 1 of which the cowl occupies its backward deployed position;

FIG. 3 is an exploded perspective view, which illustrates the mechanism of coupling and uncoupling an inlet shaft and an outlet annular ring, by means of a locking shaft according to the present disclosure;

FIG. 4 is a sectional longitudinal axial perspective view, which illustrates the mechanism of FIG. 3 in which the annular outlet ring and the inlet shaft are free in rotation;

FIG. 5 is a sectional longitudinal axial perspective view, which illustrates the mechanism of FIG. 3 in which the inlet shaft is locked in rotation;

FIG. 6 is a sectional longitudinal axial perspective view, which illustrates the mechanism of FIG. 3 in which the locking shaft, the annular outlet ring and the inlet shaft are locked in rotation;

FIG. 7 is a sectional longitudinal axial perspective view, which illustrates the mechanism of FIG. 3 in which the inlet shaft and the locking shaft are uncoupled, and the locking shaft and the annular outlet ring are locked in rotation;

FIG. 8 is a perspective view, which illustrates the mechanism of FIG. 3 comprising a receiving element composed of a toothed annular ring engaging on a motor pinion;

FIG. 9 is a perspective view, which illustrates another form of the mechanism according to the present disclosure, in which the receiving element is a receiving pinion; and

FIG. 10 is a sectional longitudinal axial perspective view, which illustrates other form in which the annular outlet ring directly engages on the outlet pinion of the locking shaft in moving position.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

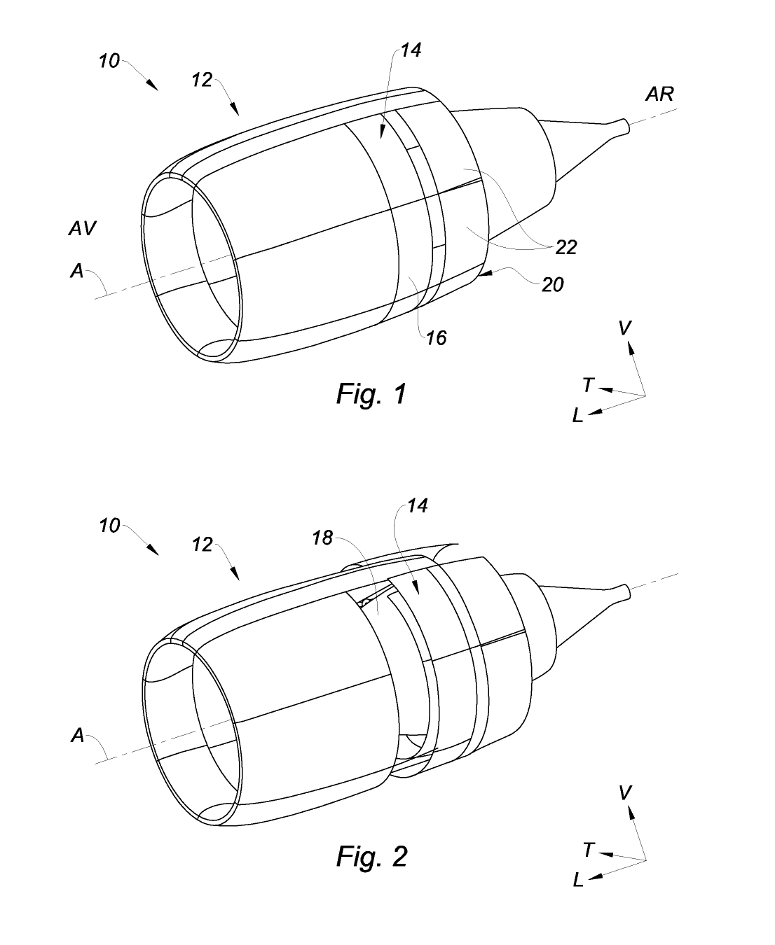

In the description and claims, it is used in a non-limiting manner the expressions “front” and “back” with reference to the left part and the right part respectively of FIGS. 1 to 10 and to marks AV for front and AR for back, on FIG. 1.

In addition, in order to clarify the description, it will be adopted in a non-limiting manner the terminology longitudinal, vertical and transversal with reference to the trihedral L, V, T indicated in the figures.

It has been represented on FIG. 1 a tubular nacelle 10 which extends along a main longitudinal axis A and which accommodates a turbojet engine designed for equipping an aircraft.

The nacelle 10 comprises in particular a structure 12 which is intended to be fixed on the aircraft, and a cowl 14 moveably mounted with respect to the structure 12.

The cowl 14 belongs to a thrust reversal device and it comprises a front portion forming the stopper 16 of a passage 18 of a diverted air flow, and a rear portion forming the ejection nozzle 20 to channel the ejection of the air flows.

To this end, the cowl 14 is slidably mounted in translation from front to back on the structure 12 of the nacelle 10, along a direction which is substantially parallel with the longitudinal axis A of the nacelle 10, between a forward compact position represented on FIG. 1, in which the cowl 14 closes the passage 18 intended for the diverted flow, and a backward deployed position represented on FIG. 2, in which the cowl 14 opens this passage 18 to allow the diverting of the flow.

Moreover, the nozzle 20 is a variable section nozzle, also called adapted nozzle, which comprises one or a set of deflectors 22 arranged in a ring shape and moveably mounted in such a manner as to make the ejection section of the air flow vary.

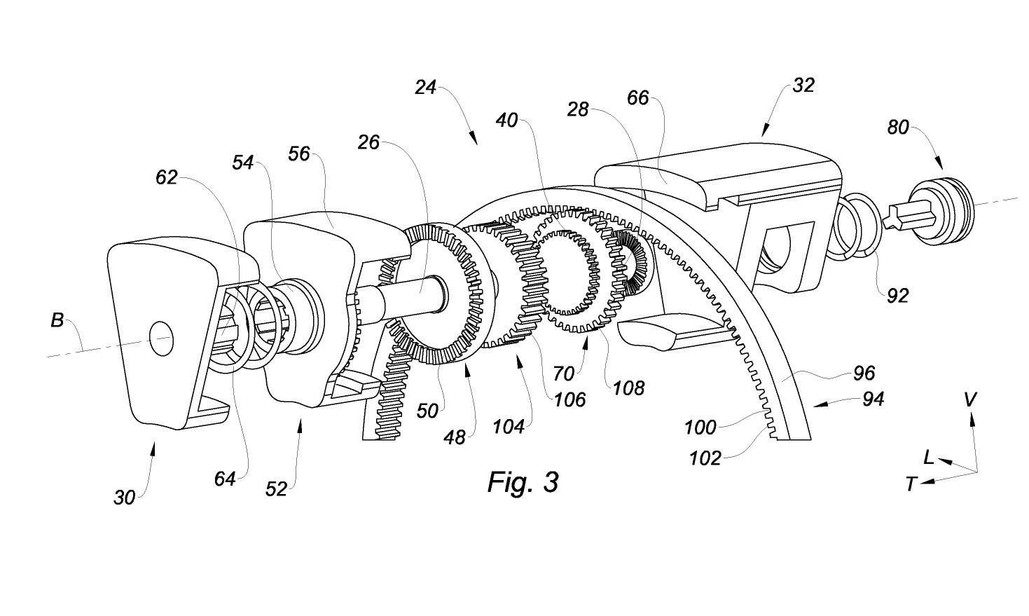

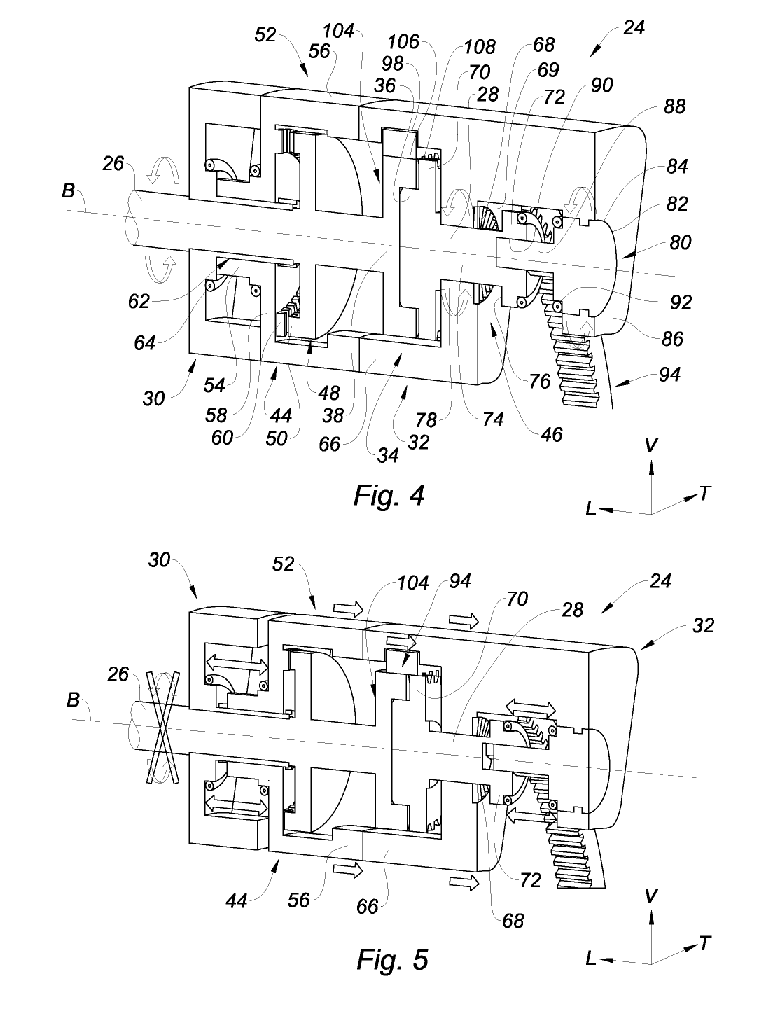

In reference to FIGS. 3 and 4, the nacelle 10 is equipped with a mechanism 24 for coupling and uncoupling a motor inlet shaft 26 and an annular outlet ring 94 by means of a locking shaft 28.

The outlet ring 94 is intended to drive in movement the deflectors 22 of the nozzle 20, when the cowl 14 occupies its forward compact position.

The inlet shaft 26 is mounted in rotation on a front frame 30 secured to the structure 12 of the nacelle 10, around a secondary longitudinal axis B, the inlet shaft 26 being driven in rotation by a motor (not represented), such as an electric motor for example.

Likewise, the outlet ring 94 is mounted in rotation on a rear frame 32 around the main longitudinal axis A, the assembly constituted by the rear frame 32 and the outlet ring 94, accompanied with its locking shaft 28 being onboard the movable cowl 14.

Thus, the rear frame 32 is slidably mounted from front to back with respect to the front frame 30, according to the secondary axis B, between a forward compact position represented on FIG. 4, and a rear deployed position represented on FIG. 7.

In a complementary manner, the mechanism 24 is equipped with a coupling means 34 which couples in rotation the inlet shaft 26 and the annular outlet ring 94 together when the rear frame 32 occupies its forward compact position, as can be seen on FIG. 4, and which uncouples the inlet shaft 26 and the annular outlet ring 94 when the rear frame 32 occupies its backward deployed position, as can be seen on FIG. 7.

The coupling means 34 is of claw type and it comprises a first female coupling portion 36 with axial toothing which is arranged on a rear axial end 38 of the inlet shaft 26, and a second male coupling portion 40 with axial toothing of complementary shape which is arranged on a front axial end 42 of the locking shaft 28, according to FIG. 7.

The first coupling portion 36 is designed to be imbricated in the second coupling portion 40 during the displacement of the rear frame 32 from its backward deployed position, towards its forward compact position.

In a non-limiting manner, it is meant by “claw” all direct coupling devices of two mechanical pieces by cooperating teeth and grooves.

In addition, the mechanism 24 comprises a first means 44 for locking in rotation the inlet shaft 26 on the associated front frame 30, and a second means 46 for locking in rotation the locking shaft 28 on the associated rear frame 32.

The first locking means 44 and the second locking means 46 are designed to automatically lock the inlet shaft 26 and the locking shaft 28 in rotation respectively, as a result of the displacement of the movable cowl 14 containing the rear frame 32 towards their backward deployed position.

To this end, the first means 44 for locking the inlet shaft 26 is of claw type and it comprises a first locking pinion 48 which is linked in rotation on the inlet shaft 26 around the secondary axis B.

As it can be seen on FIGS. 3 and 4, the first locking pinion 48 delimits a first radial toothing 50 oriented towards the front.

In addition, the first locking means 44 comprises an annular locking ferrule 52 which is constituted of a fluted axial sleeve 54 with a cylindrical portion 56 which extends axially according to the secondary axis B and an intermediary radial disk 58 which links the sleeve 54 and the cylindrical portion 56 together.

The cylindrical portion 56 is axially interposed between the front frame 30 and the rear frame 32.

The radial disk 58 delimits a second radial toothing 60 arranged facing the first complementary radial toothing 50.

Moreover, the fluted sleeve 54 of the locking ferrule 52 is slidably axially mounted on a complementary fluted section 62 of the front frame 30.

Thus, the locking ferrule 52 is slidably axially mounted according to the secondary axis B on the front frame 30, between a front unlocking position represented on FIG. 4, in which the first radial toothing 50 is arranged facing the second associated radial toothing 60, and a rear locking position represented on FIGS. 5 to 7, in which the first radial toothing 50 cooperates with the second radial toothing 60 to lock in rotation the inlet shaft 26 on the associated front frame 30.

In a complementary manner, the first locking means 44 is equipped with a first elastic return means 64, here a helical spring, which is interposed axially between the front frame 30 and a front face of the radial disk 58 of the locking ferrule 52, in such a manner as to automatically return the locking ferrule 52 towards its rear locking position.

Moreover, the rear frame 32 comprises a bearing portion 66 which axially extends towards the front and which is designed to axially bear towards the front against the cylindrical portion 56 of the locking ferrule 52, in such a manner that the locking ferrule 52 is axially constrained in its front unlocking position countering the first elastic return means 64 when the rear frame 32 occupies its forward compact position.

Furthermore, the locking ferrule 52 is released automatically in its rear locking position when the rear frame 32 is driven towards its backward deployed position with the cowl 14.

Similarly, the second means 46 for locking in rotation the locking shaft 28, and hence the annular outlet ring 94 is of claw type and it comprises a third radial toothing 68 which is fashioned on a radial wall 69 of the rear frame 32 and which is oriented towards the back.

The locking shaft 28 comprises a front locking pinion 70 and a second rear locking pinion 72 which are linked in rotation by an intermediary cylindrical section 74.

The second locking pinion 72 is linked in rotation on the locking shaft 28 around the secondary axis B, and it delimits a fourth radial toothing 76 arranged facing the third complementary radial toothing 68.

The intermediary cylindrical section 74 is slidably mounted in a bore 78 formed in the radial wall 69 of the rear frame 32.

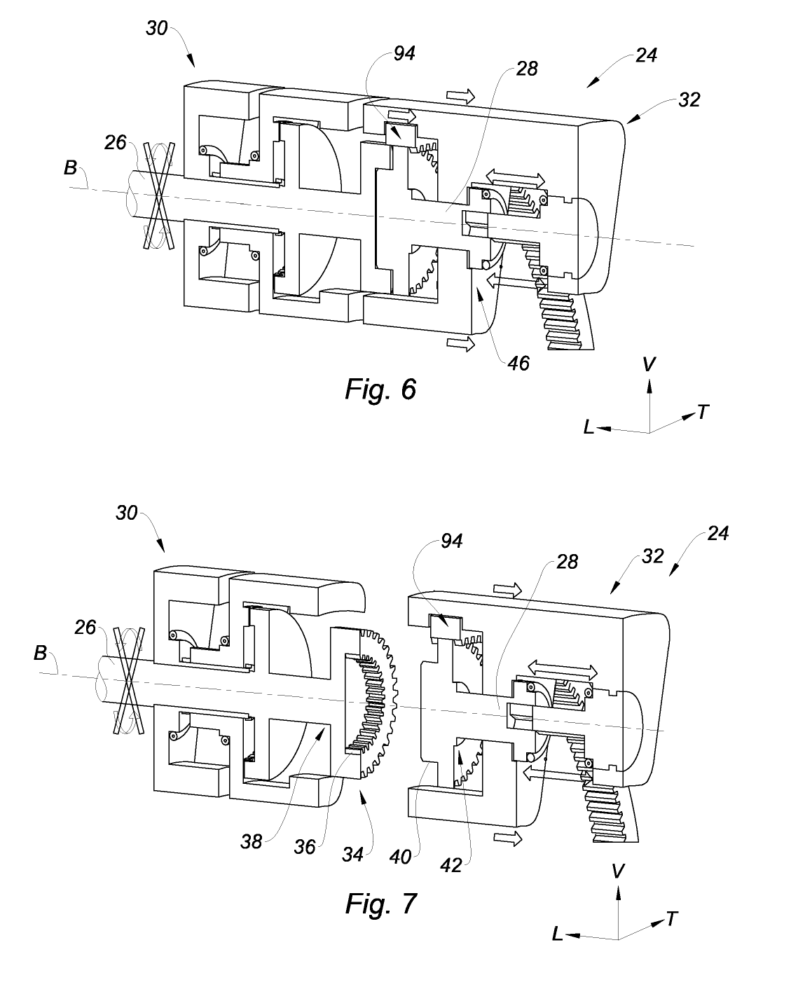

The bore 78 forms an axial sliding means for guiding the locking shaft 28 according to the secondary axis B, between a rear unlocking position, represented on FIG. 4, in which the third toothing 68 is arranged facing the fourth toothing 76, and a front locking position represented on FIGS. 6 and 7, in which the third toothing 68 cooperates with the fourth toothing 76 to lock in rotation the locking shaft 28 on the rear frame 32.

In a complementary manner, the rear frame 32 is equipped with a means (80) for slidably and rotatably guiding, which comprises a cylindrical sub plate 82 rotatably mounted around the secondary axis B in a housing 84 formed in a rear wall 86 of the rear frame 32.

Moreover, the second locking means 46 comprises a second elastic return means 92, here a helical spring, which is axially interposed between the rear wall 86 of the rear frame 32 and the second locking pinion 72, to automatically return the locking shaft 28 towards its front locking position.

The guiding means 80 comprises a fluted guiding stem 88 which extends axially towards the front from the sub plate 82 and which cooperates with a jacket 90 of complementary shape formed at the rear end of the locking shaft 28, in order to guide in axial translation the locking shaft 28 and allow following in rotation of the second elastic return means 92 when the locking shaft 28 is rotating.

Thus, the locking shaft 28 is axially constrained in its rear unlocking position countering the second elastic return means 92 when the rear frame 32, and the cowl 14, occupy their forward compact position, and the locking shaft 28 is automatically released in its front locking position when the rear frame 32, and the cowl 14, are driven towards their backward deployed position.

According to its function, the mechanism 24 according to the present disclosure drives in rotation a receiving element 94, here the annular outlet ring 94, which is mounted in rotation around the main longitudinal axis A.

The annular outlet ring 94 is designed to drive in movement the aforementioned adapted nozzle 20, by means of a drive device (not represented).

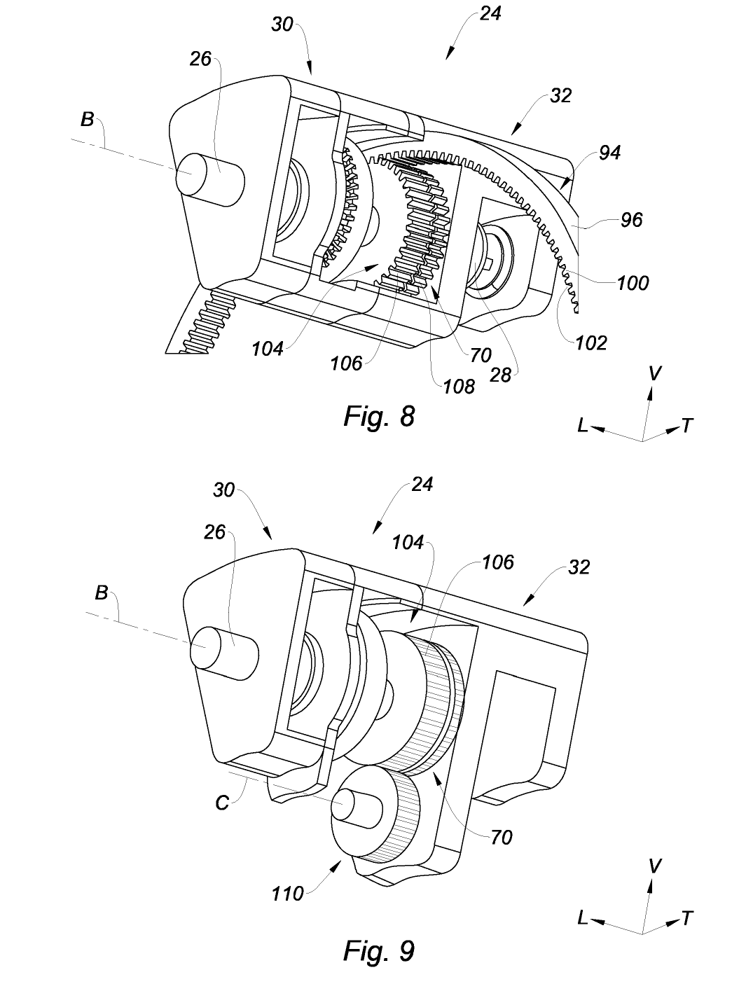

To this end, as can be seen on FIGS. 4 and 8, the annular outlet ring 94 exhibits a rectangular section and it comprises a first outer peripheral annular portion 96 which cooperates with a complementary housing 98 formed in the rear frame 32 to secure the ring 94 and the rear frame 32 in axial translation.

In addition, the ring 94 comprises a second inner annular portion 100 which delimits an axial receiving toothing 102.

In a complementary manner, the rear axial end 38 of the inlet shaft 26 is secured in rotation, around the secondary axis B, to a motor pinion 104 which delimits an axial annular toothing 106 of the same diameter as the axial toothing 108 of the locking pinion 70 mounted on the locking shaft 28.

Moreover, the motor pinion 104 is axially adjoined to the locking pinion 70 when the locking shaft 28 occupies its rear unlocking position, as can be seen on FIGS. 4 and 8.

Thus, when the rear frame 32 and the cowl 14 occupy their forward compact position, the annular outlet ring 94 occupies a moving position in which the annular outlet ring 94 engages on the motor pinion 104, in such a manner that the driving in rotation of the inlet shaft 26 causes the driving in rotation of the ring 94.

On the other hand, when the rear frame 32 and the cowl 14 occupy their backward deployed position, with reference to FIG. 7, the annular outlet ring 94 occupies a blocked position in which the locking pinion 70 engages on the annular outlet ring 94. The locking pinion 70 hence locks in rotation the annular outlet ring 94.

In order to switch from its moving position to its blocked position, the annular outlet ring 94 axially slides towards the back from the axial toothing 106 of the motor pinion 104, onto the axial toothing 108 of the locking pinion 70, during the sliding of the locking shaft 28 towards its front locking position and the displacement of the rear frame 32 towards its backward deployed position.

In the rest of the description, the automatic locking of the inlet shaft 26 and the locking shaft 28, hence of the annular outlet ring 94, is described in a chronological manner.

With reference to FIG. 4, the rear frame 32 occupies its initial forward compact position in which the inlet shaft 26 and the locking shaft 28 are free in rotation and coupled in rotation around the secondary axis B. The annular outlet ring 94 engages on the motor pinion 104 secured in rotation to the inlet shaft 26.

During the displacement of the rear cowl 14 towards the rear, the rear frame 32, which is secured in translation to the cowl 14, is driven in displacement from its forward compact position, towards its backward deployed position.

First, according to FIG. 5, the first locking means 44 locks the inlet shaft 26 in rotation by automatically displacing the locking ferrule 52 from its front unlocking position, towards its rear locking position.

Second, according to FIG. 6, the second locking means 46 locks the locking shaft 28 in rotation by displacing the locking shaft 28 from its rear unlocking position, towards its front locking position.

Moreover, during the displacement of the rear frame 32 towards its backward deployed position, the latter transfers the annular outlet ring 94 from its moving position, or driven, to its blocked position, thanks to the intervention of the locking shaft 28. The annular outlet ring 94 no longer engages with the inlet shaft 26.

Third, the coupling means 34 uncouples the inlet shaft 26 and the locking shaft 28 when the rear frame 32 reaches its backward deployed position, as can be seen on FIG. 7.

Thus, the coupling means 34 uncouples the inlet shaft 26 and the locking shaft 28 following the locking in rotation of the inlet shaft 26 and the locking shaft 28, and the locking in rotation of the annular outlet ring 94.

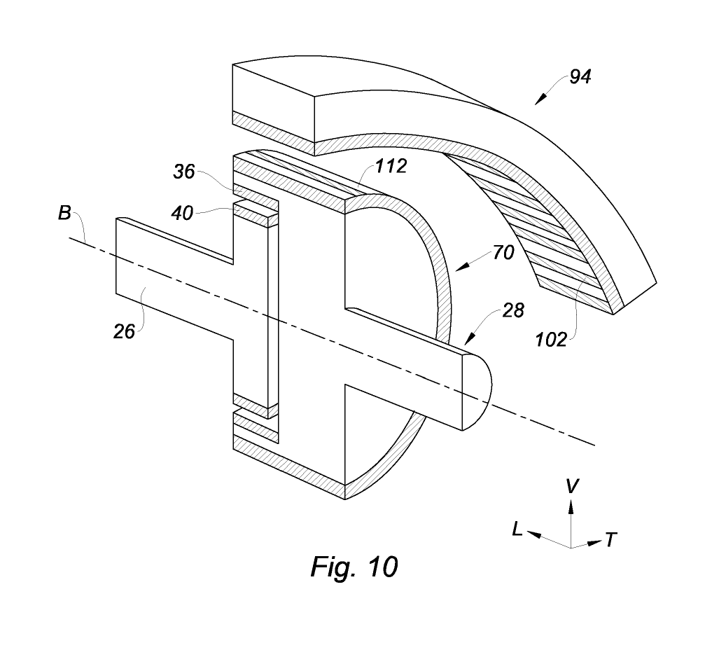

According to another form represented on FIG. 10, the pinion 70 of the locking shaft 28 delimits a toothing 112 which is sufficiently wide axially so that the toothing 102 of the annular outlet ring 94 permanently cooperates with the toothing 112 of the pinion 70 of the locking shaft 28, during the displacement of the annular outlet ring 94 from its moving position, to its blocked position.

Thus, as FIG. 10 shows, when the rear frame 32 occupies its forward compact position, the annular outlet ring 94 occupies its moving position in which it directly engages on the outlet pinion 70 of the locking shaft 28.

According to this form, in order to switch from its moving position to its blocked position, the annular outlet ring 94 axially slides on the axial toothing 112 of the locking pinion 70, during the sliding of the locking shaft 28 towards its front locking position and the displacement of the rear frame 32 towards its backward deployed position.

According to other form represented on FIG. 9, the annular outlet ring 94 is replaced with a receiving pinion 110 which is mounted in rotation around a longitudinal receiving axis C on the rear frame 32.

In a non-limiting manner, the cylindrical toothings of the different transmission pinions may be replaced with conical toothings.

Likewise, the links and guiding of the components in rotation may be provided by bearings, or rollings, or other equivalent systems able to provide a rotational or sliding guiding.

What is claimed is:

1. A mechanism for coupling and uncoupling an inlet shaft which is mounted in rotation on a front frame around a secondary longitudinal axis, and an outlet shaft which is mounted in rotation on a rear frame around the secondary axis and which drives in rotation an outlet pinion, the rear frame being slidably mounted from front to back with respect to the front frame, along a longitudinal direction, between a forward compact position and a backward deployed position, said mechanism comprising:
a coupling means configured to couple in rotation the inlet shaft and the outlet shaft together when the rear frame occupies the forward compact position, the coupling means configured to uncouple the inlet shaft and the outlet shaft when the rear frame occupies the backward deployed position;
a first means for locking in rotation the inlet shaft on the front frame; and
a second means for locking in rotation the outlet shaft on the rear frame, the second means configured to automatically lock the inlet shaft and the outlet shaft in rotation respectively, under the effect of a displacement of the rear frame towards the backward deployed position.

2. The mechanism according to claim 1, wherein the first means for locking the inlet shaft, of claw type, comprises:
a first locking pinion which is linked in rotation on the inlet shaft around the secondary axis and which delimits a first radial toothing oriented towards the front;
a locking ferrule which delimits a second radial toothing arranged facing the first radial toothing, the locking ferrule being slidably mounted axially on the front frame between a front unlocking position in which the first radial toothing is arranged facing the second radial toothing, and a rear locking position in which the first radial toothing cooperates with the second radial toothing to lock in rotation the inlet shaft on the front frame; and
a first elastic return means which is axially interposed between the front frame and the locking ferrule, the first elastic return means configured to automatically returns the locking ferrule towards the rear locking position,
wherein the rear frame comprises a bearing portion which axially bears against the locking ferrule towards the front, such that the locking ferrule is axially constrained in the front unlocking position countering the first elastic return means when the rear frame occupies the forward compact position, and the locking ferrule is automatically released in the rear locking position when the rear frame is driven towards the backward deployed position.

3. The mechanism according to claim 1, wherein the second means for locking the outlet shaft, of claw type, comprises:
a third radial toothing which is integral with the rear frame and which is oriented backwards;
a second locking pinion which is linked in rotation on the outlet shaft around the secondary axis and which delimits a fourth radial toothing arranged facing the third radial toothing;
an axial sliding means for guiding the outlet shaft between a rear unlocking position in which the third radial toothing is arranged facing the fourth radial toothing, and a front locking position in which the third radial toothing cooperates with the fourth radial toothing to lock in rotation the outlet shaft on the rear frame; and
a second elastic return means which is axially interposed between the rear frame and the second locking pinion to automatically return the outlet shaft towards the front locking position, such that the outlet shaft is axially constrained in the rear unlocking position countering the second elastic return means when the rear frame occupies the forward compact position, and the outlet shaft is automatically released in the front locking position when the rear frame is driven towards the backward deployed position.

4. The mechanism according to claim 1, wherein the first means for locking locks the inlet shaft before the second means for locking locks the outlet shaft.

5. The mechanism according to claim 1, wherein the coupling means uncouples the inlet shaft and the outlet shaft after the locking in rotation of the inlet shaft and the outlet shaft.

6. The mechanism according to claim 1, wherein the coupling means is of claw type and comprises a first coupling portion with axial toothing being arranged on a rear axial end of the inlet shaft, and a second coupling portion with axial toothing of complementary shape which is arranged on a front axial end of the outlet shaft.

7. The mechanism according to claim 1, wherein the mechanism drives in rotation a receiving element which is mounted in rotation around a main longitudinal axis, the receiving element configured to drive in movement an adapted nozzle of a turbojet engine.

8. The mechanism according to claim 7, wherein the inlet shaft is secured in rotation to a motor pinion which delimits a toothing of the same diameter as a toothing of the outlet pinion, and the motor pinion is axially adjoined to the outlet pinion when the outlet shaft occupies the rear unlocking position, and wherein the receiving element is secured in axial translation to the rear frame, the receiving element delimiting a receiving toothing configured to axially slide from the toothing of the motor pinion, onto the toothing of the outlet pinion during the sliding of the outlet shaft towards the front locking position to allow the locking in rotation of the receiving element.

9. The mechanism according to claim 8, wherein the receiving element is an annular ring, the annular ring comprising:
an outer peripheral annular portion which cooperates with a complementary housing formed in the rear frame to secure the receiving element and the rear frame in axial translation; and
an inner annular portion which delimits the receiving toothing configured to engage with the motor pinion and the outlet pinion.

10. The mechanism according to claim 1, wherein the rear frame is carried by a movable cowl of an onboard thrust reversal device of a turbojet engine.

11. A nacelle of turbojet engine comprising the mechanism for coupling and uncoupling according to claim 1.
